(19) United States
(12) Patent Application Publication
(10) Pub. No.: US 2024/0088346 A1
(43) Pub. Date: Mar. 14, 2024

(54) SOLID-STATE BATTERY AND SOLID-STATE BATTERY MANUFACTURING METHOD

(71) Applicant: BEILab corp., Ansan-si, Gyeonggi-do (KR)

(72) Inventor: Jihyun SEO, Suwon-si, Gyeonggi-do (KR)

(21) Appl. No.: 18/550,969

(22) PCT Filed: Mar. 31, 2022
(86) PCT No.: PCT/KR2022/004609

§ 371 Date: Sep. 17, 2023

(30) Foreign Application Priority Data
Apr. 22, 2021 (KR) 10-2021-0052421

(51) Int. Cl. H01M 4/04; H01M 10/0562

(52) U.S. Cl. CPC H01M 4/0435; H01M 10/0562

(57) ABSTRACT

The present invention relates to a solid-state battery and a manufacturing method therefor, the solid-state battery comprising a solid electrolyte film and a solid electrode film attached to one surface of the electrolyte film through compression, wherein the electrolyte film does not comprise polymers and is formed from an amorphous material having a preset density. According to the present invention, since a lithium layer and a polymer are not used, the ion conductivity and productivity of the solid-state battery can be improved.

### TECHNICAL FIELD

The present invention relates to a solid-state battery and a method of manufacturing the same, and more particularly to a solid-state battery capable of being manufactured without a lithium layer and without an organic electrolyte, such as a polymer, during a manufacturing process, and a method of manufacturing the same.

### BACKGROUND ART

A solid-state battery is a battery in which a conventional liquid electrolyte between a positive electrode and a negative electrode is replaced by a solid electrolyte.

In a general conventional battery including a liquid electrolyte, there is a danger of fire breaking out if a positive electrode and a negative electrode come into contact with each other. Since an electrolyte of a solid-state battery, in which lithium ions move, is made of a solid, however, the electrolyte and electrode remain fixed at all times, whereby the solid-state battery may be normally operated without damage or explosion in the event of a disturbance.

Meanwhile, a polymer is mainly used as the material for the solid-state battery in order to increase productivity. For example, an electrode film may be attached to an electrolyte film. In this case, an organic material, such as a polymer, may be used for the purpose of bonding and molding the electrolyte film and the electrode film.

For example, Korean Registered Patent No. 10-1211968 discloses a method using a polymer without a solvent in order to solve the problem of a wet process using a large amount of solvent in manufacturing a battery.

If an organic electrolyte material, such as a polymer, is used for bonding and molding purposes, however, there is a problem in that ionic conductivity or stability against temperature change is reduced.

In addition, conventionally, a film made of lithium is often used as the material for a negative electrode.

However, the lithium film (lithium layer) is not only easily oxidized but can also melt at a relatively low temperature, and therefore manufacture and performance maintenance are not easy.

### DISCLOSURE

### Technical Problem

The present invention has been made in view of the above problems, and it is an object of the present invention to provide a solid-state battery having no lithium layer and a method of manufacturing the same.

It is another object of the present invention to provide a solid-state battery using no polymer and a method of manufacturing the same.

It is a further object of the present invention to provide a solid-state battery configured such that a solid electrolyte (or a solid electrolyte film) and an electrode (or an electrode film) are directly attached to each other without a polymer, whereby ionic conductivity and productivity are improved, and a method of manufacturing the same.

### Technical Solution

In order to accomplish the above objects, the present invention provides a method of manufacturing a solid-state battery by coupling a solid electrolyte film including no polymer and a solid electrode film to each other, the method including a supply step of supplying an electrolyte film and an electrode film and a pressing step of attaching one surface of the electrolyte film and one surface of the electrode film to each other by pressing, wherein the electrolyte film is formed of an amorphous material having a predetermined density. Consequently, it is possible to easily attach the electrode film and the electrolyte film to each other by pressing without an organic electrolyte, such as a polymer.

When the normalized density of a crystalline solid formed of the same material as the electrolyte film is defined as 1, the corresponding density of the electrolyte film may be less than 1. Consequently, it is possible to easily attach the electrode film and the electrolyte film to each other by pressing without an organic electrolyte, such as a polymer.

In the supply step, the electrolyte film and the electrode film may be guided between a pair of rollers in the state in which one surface of the electrolyte film and one surface of the electrode film face each other, and in the pressing step, the electrolyte film and the electrode film may be pressed against each other while passing between the pair of rollers. Consequently, it is possible to continuously press the electrode film and the electrolyte film and to mass-produce the solid-state battery.

In the pressing step, the pair of rollers may be heated to a predetermined temperature by a heating unit. Consequently, it is possible to improve efficiency in attachment between the electrode film and the electrolyte film by pressing.

The method may further include a step of attaching a metal foil to each of the other surface of the electrode film and the other surface of the electrolyte film before the supply step. Consequently, only the electrode film and the electrolyte film may be attached to each other by pressing, whereby it is possible to more easily mass-produce the solid-state battery.

The present invention provides a solid-state battery manufactured using the method.

In addition, the present invention provides a solid-state battery including an electrode film and an electrolyte film attached to one surface of the electrode film by pressing, wherein the electrolyte film is formed of an amorphous material having a predetermined density.

When the normalized density of a crystalline solid formed of the same material as the electrolyte film is defined as 1, the normalized density of the electrolyte film may be less than 1.

The electrolyte film and the electrode film may be attached to each other while passing between a pair of pressing rollers in the state in which one surface of the electrolyte film and one surface of the electrode film face each other.

The electrolyte film and the electrode film may be attached to each other by the pair of pressing rollers heated by a heating unit.

Metal foils may be attached to the other surface of the electrode film and the other surface of the electrolyte film.

The metal foils may include a first metal foil disposed on the other surface of the electrode film and a second metal foil disposed on the other surface of the electrolyte film.

The first metal foil may be formed so as to function as a positive electrode current collector, and the second metal foil may be formed so as to function as a negative electrode current collector.

The electrode film may be a positive electrode layer, and the electrolyte film may be an electrolyte layer.

The present invention provides a method of manufacturing a solid-state battery, the method including a supply step of supplying a solid electrolyte film and a solid electrode film and a pressing step of attaching one surface of the electrolyte film and one surface of the electrode film that faces the one surface of the electrolyte film to each other by pressing, wherein the electrolyte film is formed of an amorphous material, and when the normalized density of a crystalline solid formed of the same material as the electrolyte film is defined as 1, the normalized density of the electrolyte film is less than 1.

### Advantageous Effects

According to the present invention, it is possible to provide a solid-state battery having no lithium layer and a method of manufacturing the same.

In addition, according to the present invention, it is possible to provide a solid-state battery using no polymer and a method of manufacturing the same.

In addition, according to the present invention, it is possible to provide a solid-state battery configured such that an electrolyte film and an electrode film are directly attached to each other without a polymer, whereby ionic conductivity and productivity are improved, and a method of manufacturing the same.

### DESCRIPTION OF DRAWINGS

FIG. 1 is a conceptual view showing a solid-state battery having no lithium layer.

FIG. 2 is a conceptual view showing components configured to manufacture the solid-state battery having no lithium layer.

FIG. 3 is a flowchart showing a method of manufacturing the solid-state battery having no lithium layer.

### BEST MODE

Hereinafter, a method of manufacturing a solid-state battery according to an embodiment of the present invention will be described in detail with reference to the accompanying drawings. The accompanying drawings show exemplary forms of the present invention, which are provided for the purpose of describing the present invention in more detail and are not intended to limit the technical scope of the present invention.

In addition, identical or corresponding elements are designated by the same reference numerals irrespective of figure numbers, and a duplicate description thereof will be omitted. Furthermore, the size and shape of each element shown may be exaggerated or reduced for convenience of description.

Meanwhile, terms containing ordinal numbers, such as first or second, may be used to describe various elements; however, the elements are not limited by the terms, and the terms are used only to distinguish one element from another.

In addition, in describing the present invention, a detailed description of related prior art will be omitted if it is determined that a detailed description of the related prior art would obscure the gist of the present invention.

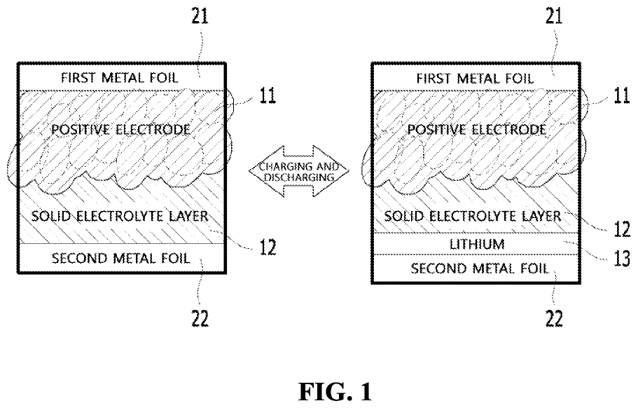

FIG. 1 is a conceptual view of a solid-state battery.

Referring to FIG. 1, a solid-state battery according to an embodiment of the present invention may include an electrode film 11 (also referred to as a “positive electrode film” or a “positive electrode layer”), an electrolyte film 12 (also referred to as an “electrolyte layer”), a first metal foil 21, and a second metal foil 22.

Each of the electrode film 11, the electrolyte film 12, the first metal foil 21, and the second metal foil 22 may be formed as a solid.

The electrolyte film 12 may be disposed on one surface of the electrode film 11 (a lower surface of the electrode film in FIG. 1). The first metal foil 21 may be disposed on the other surface of the electrode film 11 (an upper surface of the electrode film in FIG. 1).

That is, the electrolyte film 12 may be attached to one surface of the electrode film 11, and the first metal foil 21 may be attached to the other surface of the electrode film 11. Here, the other surface of the electrode film 11 may mean the surface of the electrode film 11 disposed opposite one surface thereof.

The electrode film 11 may be disposed on one surface of the electrolyte film 12 (an upper surface of the electrolyte film in FIG. 1). The second metal foil 22 may be disposed on the other surface of the electrolyte film 12 (a lower surface of the electrolyte film in FIG. 1).

That is, the electrode film 11 may be attached to one surface of the electrolyte film 12, and the second metal foil 22 may be attached to the other surface of the electrolyte film 12. Here, the other surface of the electrolyte film 12 may mean the surface of the electrolyte film 12 disposed opposite one surface thereof.

The first metal foil 21 and the second metal foil 22 may be formed of different metals. For example, the first metal foil 21 may be formed of aluminum (Al), and the second metal foil 22 may be formed of copper (Cu) or stainless steel (SUS).

The first metal foil 21 may be formed so as to function as a positive electrode current collector (or a positive electrode current collection electrode), and the second metal foil 22 may be formed so as to function as a negative electrode current collector (or a negative electrode current collection electrode).

The electrode film 11 may be formed of a lithium compound. For example, the electrode film 11 may be formed of LiCoO₂, LiO₂, LiNi_{1/3}Co_{1/3}Mn_{1/3}O₂, LiMn₂O₄, LiFePO₄, or LiS.

As shown in FIG. 1, the solid-state battery includes no separate negative electrode film. During discharging of the solid-state battery, however, lithium ions of the electrode film 11 may move, whereby a lithium layer 13 may be formed between the electrolyte film 12 and the second metal foil 22, and the lithium layer 13 may function as a negative electrode. During charging of the solid-state battery, on the other hand, lithium ions of the lithium layer 13 move back to the electrode film 11, whereby the lithium layer 13 disappears.

According to the present invention, as described above, even though no lithium film (or no lithium layer) is provided during manufacture of the solid-state battery, a lithium layer as a negative electrode may be formed as the result of movement of lithium ions included in the electrode film during operation of the solid-state battery.

That is, it is not necessary to separately provide a lithium film (a lithium layer), which is easily oxidized and can melt at a relatively low temperature, during manufacture of the solid-state battery, whereby it is possible to easily manufacture and mass-produce the solid-state battery.

A solid-state electrolyte, as an electrolyte, may be classified as an inorganic solid electrolyte, a solid polymer electrolyte, or a composite polymer electrolyte.

The solid polymer electrolyte is a solvent-free salt solution of a polymer host material that conducts ions through a polymer chain. The solid polymer electrolyte is easy to manufacture by solution casting, and therefore the solid polymer electrolyte is suitable for a large-scale manufacturing process. Since polymer is used, however, ionic conductivity of the solid polymer electrolyte is lower than ionic conductivity of the inorganic solid electrolyte and the conductivity thereof is low, whereby the solid polymer electrolyte is limited in fast charging.

The composite polymer electrolyte may be formed by adding particles to a polymer solution. The composite polymer electrolyte also has a problem of low ionic conductivity due to the use of a polymer.

In contrast, the inorganic solid electrolyte is formed of an inorganic material in a crystalline or glassy state, and conduction of ions occurs by diffusion through a lattice. The inorganic solid electrolyte has advantages of high ionic conductivity, high strength (GPa level), and high transport number.

According to the embodiment of the present invention, the electrolyte film 12 may be formed of an inorganic solid electrolyte. In addition, for example, the electrolyte film 12 may be formed of an oxide solid electrolyte or a sulfide solid electrolyte.

Since the electrolyte film 12 includes no polymer, as described above, it is possible to provide a solid-state battery having good ionic conductivity.

Meanwhile, a polymer may be used as the material for a binder configured to attach the electrode film and the electrolyte film to each other. When the polymer is used, as described above, ionic conductivity may be reduced.

According to the present invention, the electrode film 11 and the electrolyte film 12 may be attached to each other by pressing without using the polymer.

Specifically, the electrolyte film 12 may be formed of an amorphous material. That is, the electrolyte film 12 may be formed as an amorphous solid. Consequently, the electrolyte film 12 and the electrode film 11 may be attached to each other by pressing of the electrolyte film 12 and the electrode film 11.

In particular, when the normalized density S of a crystalline solid formed of the same material as the electrolyte film 12 is defined as 1, it is preferable for the normalized density of the electrolyte film 12 to be less than 1. That is, the normalized density of the electrolyte film 12 may be greater than 0 and less than 1. Here, the normalized density is a number defined to compare the density of a crystalline solid and the density of an amorphous solid of the same material.

That is, an amorphous solid formed at a low temperature outside a thermodynamically stable range may have a density in which the distance between atoms is equal to or greater than a stable distance (i.e. a normalized density less than 1). That is, synthesis of a low-density amorphous solid is possible. Since synthesis of such a low-density amorphous solid is already known, a detailed description thereof will be omitted.

Since the electrolyte film 12 is formed of a low-density amorphous material (amorphous solid), the electrolyte film 12 and the electrode film 11 may be attached to each other by pressing without an organic electrolyte such as a polymer.

Hereinafter, a configuration for attaching the electrolyte film 12 and the electrode film 11 to each other by pressing will be described with reference to another figure.

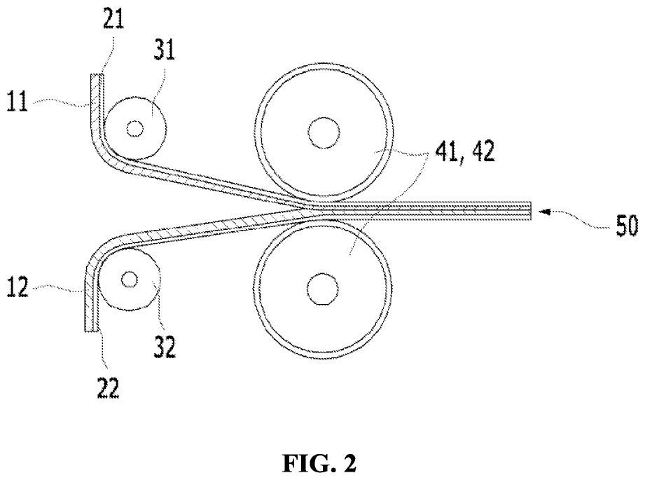

FIG. 2 is a conceptual view showing components configured to manufacture the solid-state battery having no lithium layer. Specifically, FIG. 2 is a view showing a process in which the electrolyte film and the electrode film of the solid-state battery are attached to each other by pressing.

Referring to FIG. 2, the present invention includes a pair of pressing rollers 41 and 42 configured to attach the electrode film 11 and the electrolyte film 12 to each other. The pair of pressing rollers 41 and 42 may include a first pressing roller 41 and a second pressing roller 42 spaced apart from the first pressing roller 41 by a predetermined distance.

Although not shown, at least one of the first pressing roller 41 and the second pressing roller 42 may be coupled to a separate moving unit configured to move the first pressing roller and the second pressing roller so as to move toward or away from each other. The distance between the pair of pressing rollers 41 and 42 may be determined in consideration of the thickness and pressing strength of the electrode film 11 and the electrolyte film 12 entering between the pair of pressing rollers 41 and 42.

The electrolyte film 12 and the electrode film 11 may be guided between the pair of pressing rollers 41 and 42 in the state in which one surface of the electrolyte film and one surface of the electrode film face each other. In the shown embodiment, the first pressing roller 41 may be disposed above the electrode film 11, and the second pressing roller 42 may be disposed under the electrolyte film 12.

The present invention may further include a pair of guide rollers 31 and 32 configured to guide the electrode film 11 and the electrolyte film 12 between the pair of pressing rollers 41 and 42.

The pair of guide rollers 31 and 32 includes a first guide roller 31 configured to guide the electrode film 11 between the pair of pressing rollers 41 and 42 and a second guide roller 32 configured to guide the electrolyte film 12 between the pair of pressing rollers 41 and 42.

The pair of guide rollers 31 and 32 may be formed so as to be movable in at least one of an upward-downward direction and a leftward-rightward direction through a moving unit that is not shown. Tension of the electrode film 11 and the electrolyte film 12 may be adjusted through movement of the pair of guide rollers 31 and 32. For example, the tension of the electrode film 11 and the electrolyte film 12 may be maintained at a predetermined tension through the pair of guide rollers 31 and 32.

The electrode film 11 and the electrolyte film 12 may be pressed against each other during passage between the pair of pressing rollers 41 and 42. One surface of the electrode film 11 and one surface of the electrolyte film 12 (i.e. facing surfaces of the electrode film 11 and the electrolyte film 12) may be attached to each other by pressing.

Since the electrolyte film 12 is formed of an amorphous material having a predetermined density, as previously described, one surface of the electrode film 11 may be attached to one surface of the electrolyte film 12 by pressing without an organic electrolyte such as a polymer.

Also, in order to improve efficiency in attachment between the electrode film 11 and the electrolyte film 12, the pair of pressing rollers 41 and 42 may be heated to a predetermined temperature by a heating unit (not shown). For example, the pair of pressing rollers 41 and 42 may be heated to 100° C. to 400° C. The reason for this is that, when the predetermined temperature is less than 100° C., improvement in attachment efficiency may be insignificant, and when the predetermined temperature is greater than 400° C., the electrode film 11 and the metal foils 21 and 22 may be damaged by oxidation or deterioration.

The electrode film 11 and the electrolyte film 12 may be supplied between the pair of pressing rollers 41 and 42 in the state in which the other surface of the electrode film 11 and the other surface of the electrolyte film 12 are attached respectively to the metal foils 21 and 22.

That is, before the electrode film 11 and the electrolyte film 12 may be supplied between the pair of pressing rollers 41 and 42, the first metal foil 21 may be attached to the other surface of the electrode film 11 in advance, and the second metal foil 22 may be attached to the other surface of the electrolyte film 12 in advance.

Consequently, the electrode film 11 having the first metal foil 21 attached thereto and the electrolyte film 12 having the second metal foil 22 attached thereto may be continuously pressed by the pair of pressing rollers 41 and 42, whereby it is possible to continuously manufacture and mass-produce the solid-state battery 50.

Hereinafter, a method of manufacturing the solid-state battery according to the present invention will be described with further reference to another figure.

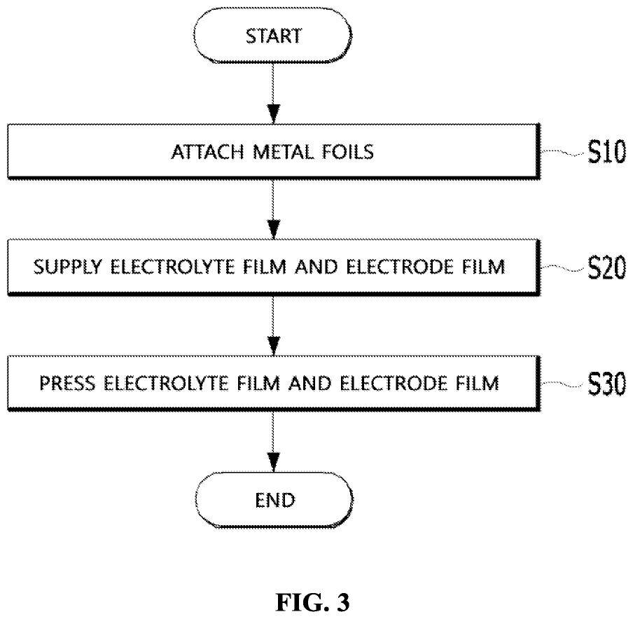

FIG. 3 is a flowchart showing a method of manufacturing the solid-state battery having no lithium layer. In hereinafter describing the method of manufacturing the solid-state battery, it is obvious that the construction and features of the solid-state battery described with reference to FIGS. 1 and 2 may be equally applied to the method of manufacturing the solid-state battery.

Also, in the method of manufacturing the solid-state battery according to the present invention, components of the solid-state battery may include no lithium film (no lithium layer) and no polymer, and the solid-state battery may be manufactured by coupling a solid electrolyte film and a solid electrode film.

Referring to FIGS. 1 to 3, the method of manufacturing the solid-state battery according to the present invention may include a supply step (S20) of supplying an electrolyte film 12 and an electrode film 11 and a pressing step (S30) of attaching the electrolyte film 12 and the electrode film 11 to each other.

In the supply step (S20), an electrolyte film 12 and an electrode film 11 may be supplied. At this time, the electrolyte film 12 and the electrode film 11 may be supplied in the state in which one surface of the electrolyte film and one surface of the electrode film face each other. One surface of the electrolyte film 12 and one surface of the electrode film 11 are surfaces that face each other and correspond to surfaces to be attached.

In the pressing step (S30), one surface of the electrolyte film 12 and one surface of the electrode film 11 may be attached to each other by pressing.

In particular, it is preferable for the electrolyte film 12 to be formed of an amorphous material having a predetermined density. Consequently, one surface of the electrode film 11 may be attached to one surface of the electrolyte film 12 that faces the same by pressing without an organic electrolyte such as a polymer.

For example, when the normalized density of a crystalline solid formed of the same material as the electrolyte film 12 is defined as 1, it is preferable for the normalized density of the electrolyte film 12 to be less than 1. One surface of the electrode film 11 may be easily attached to one surface of the electrolyte film 12 that faces the same by pressing due to characteristics of the electrolyte film 12. Since no polymer is used, decrease in ionic conductivity may be prevented.

Specifically, in the supply step (S20), the electrolyte film 12 and the electrode film 11 may be guided between a pair of pressing rollers 41 and 42 in the state in which one surface of the electrolyte film and one surface of the electrode film face each other. That is, the electrolyte film 12 and the electrode film 11 may be continuously guided between the pair of pressing rollers 41 and 42 in a longitudinal direction.

In the supply step S20, the electrode film 11 and the electrolyte film 12 may be guided between the pair of pressing rollers 41 and 42 by a pair of guide rollers 31 and 32. In addition, tension of the electrode film 11 and the electrolyte film 12 may be adjusted within a desirable tension range by position shift of the pair of guide rollers 31 and 32.

In the pressing step (S30), the electrolyte film 12 and the electrode film 11 may be pressed against each other while passing between the pair of pressing rollers 41 and 42. That is, the electrolyte film 12 and the electrode film 11 may be continuously pressed against each other while continuously passing between the pair of pressing rollers 41 and 42 in the longitudinal direction.

Consequently, the solid-state battery may be easily mass-produced through pressing of the electrolyte film 12 and the electrode film 11.

In the pressing step (S30), the pair of pressing rollers 41 and 42 may be heated to a predetermined temperature by a heating unit (not shown). The heating temperature of the pair of pressing rollers 41 and 42 is as described above, and efficiency in attachment between the electrolyte film 12 and the electrode film 11 by pressing may be improved by heating the pair of pressing rollers 41 and 42.

The method of manufacturing the solid-state battery according to the present invention may further include a step (S10) of attaching metal foils 21 and 22 to the other surface of the electrode film 11 and the other surface of the electrolyte film 12, respectively, before the supply step (S20). Here, the other surface of the electrode film 11 and the other surface of the electrolyte film 12 may be surfaces far from each other and may mean surfaces opposite one surface of the electrode film and one surface of the electrolyte film.

Specifically, before the supply step (S20), a first metal foil 21 may be attached to the other surface of the electrode film 11 in advance, and a second metal foil 22 may be attached to the other surface of the electrolyte film 12 in advance.

Consequently, only the electrode film 11 and the electrolyte film 12 may be attached to each other by continuous pressing, whereby it is possible to more easily mass-produce the solid-state battery.

The preferred embodiment of the present invention described above is disclosed for the purpose of illustration, and those skilled in the art will appreciate that various modifications, changes, and additions are possible within the spirit and scope of the present invention and that such modifications, changes, and additions fall within the scope of the appended claims.

### DESCRIPTION OF REFERENCE NUMERALS

11 Electrode film
12 Electrolyte film
21 First metal foil
22 Second metal foil
31 First guide roller
32 Second guide roller
41 First pressing roller
42 Second pressing roller
50 Solid-state battery

1. A method of manufacturing a solid-state battery by coupling a solid electrolyte film and a solid electrode film to each other, the method comprising:
a step of attaching a metal foil to each of the electrode film and the electrolyte film;
a supply step of supplying an electrolyte film and an electrode film between a pair of pressing rollers including a first pressing roller and a second pressing roller; and
a pressing step of attaching one surface of the electrolyte film and one surface of the electrode film to each other by pressing without binder material, wherein
the electrolyte film is formed of an amorphous material having a predetermined density, when a normalized density of a crystalline solid formed of the same material as the electrolyte film is defined as 1, the normalized density of the electrolyte film is less than 1,
in the supply step, at least one of the first pressing roller and the second pressing roller is moved toward or away from each other by a moving unit,
in the supply step, tension of the electrode film and the electrolyte film is adjusted by a pair of guide rollers for guiding the electrode film and the electrolyte film between the pair of pressing rollers,
in the pressing step, the electrode film and the electrolyte film are pressed against each other by the pair of pressing rollers heated to 100° C. to 400° C.

2. (canceled)

3. The method according to claim 1, wherein
in the supply step, the electrolyte film and the electrode film are guided between a pair of pressing rollers in a state in which the one surface of the electrolyte film and the one surface of the electrode film face each other, and
in the pressing step, the electrolyte film and the electrode film are pressed against each other while passing between the pair of pressing rollers.

4. The method according to claim 3, wherein, in the pressing step, the pair of pressing rollers is heated to a predetermined temperature by a heating unit.

5. (canceled)

6. A solid-state battery manufactured using the method according to claim 1.

7-15. (canceled)
